(19) United States
(12) Patent Application Publication
(10) Pub. No.: US 2025/0308530 A1
(43) Pub. Date: Oct. 2, 2025

(54) INTERACTIVE REAL-TIME VOICE-TO-TEXT TRANSCRIPTION SYSTEM AND METHODS

(71) Applicant: Occurio Solutions, LLC, St. Louis, MO (US)

(72) Inventor: Timothy J. Hudson, St. Louis, MO (US)

(73) Assignee: Occurio Solutions, LLC, St. Louis, MO (US)

(21) Appl. No.: 18/624,129

(22) Filed: Apr. 2, 2024

(51) Int. Cl. G10L 15/26; G06F 3/04817; G06F 40/169; H04L 65/60

(52) U.S. Cl. CPC G10L 15/26; G06F 3/04817; G06F 40/169; H04L 65/60

(57) ABSTRACT

An interactive, real-time voice-to-text transcription system and method that includes a microphone device that records verbal audio from a Speaker at a live event or leading a guided tour, an Audience Member user interface for viewing a real-time transcription of the Speaker's audio presentation and providing feedback and/or asking questions during the live event or guided tour, and a Speaker user interface that permits the Speaker to see the feedback provided by Audience Members and questions posed by Audience Members during an live event or guided tour. The system of the present invention further provides for the collection and reporting of data relevant to the live event or guided tour for the purpose of assessing the quality of the live event or guided tour and identifying changes that can be implemented to improve the quality of future live events or guided tours.

### STATEMENT REGARDING FEDERALLY SPONSORED RESEARCH OR DEVELOPMENT

This invention was made with no government support or sponsorship.

### RELATED PATENT APPLICATIONS AND INCORPORATION BY REFERENCE

Not applicable.

### FIELD OF THE INVENTION

The present invention relates to the field of real-time audio transcription systems. More specifically, the present disclosure relates to a system and methods to enable guided tour or event participants to receive a real-time transcript of a tour guide's or event speaker's verbal presentation.

### BACKGROUND OF THE INVENTION

Guided tours are a very important event experience that functions as a key component of the college and university admissions process. The experience of a live, in-person guided tour offers a variety of advantages above a virtual tour experience that technology has made a possibility for prospective students desiring to learn about particular colleges of interest. The in-person guided tour offers a more personal and intimate experience undoubtedly, however it has many limitations as well. Additionally, guided tour participants who have certain disabilities, such as a hearing impairment, experience difficulty in fully enjoying the experience of a live guided tour when they don't have access to an in-person interpreter.

It is estimated that over thirty million people in the United States suffer from some form of hearing impairment. Roughly ten million of those hearing-impaired individuals having difficulty hearing to such an extent that even a conventional hearing aid does not enable hearing normal conversation.

Hearing impairment can be a significant problem when it comes to enjoying the full experience of a live guided tour. Unfortunately, there are very few resources or solutions available to solve this problem. Of course it is possible to have the tour audio recorded and transcribed after the tour. However, reading a transcription post-event is just not the same as having a real-time transcription as the guided tour actually occurs so that it is accessible instantly to a person with hearing impairment.

Unfortunately, the traditional campus tour has remained analog and largely unchanged for decades. Many other distractions and interruptions, such as wind, traffic, loud campus activities, poor building acoustics, and city noises can be very problematic in terms of tour participants being able to hear the tour guide's voice. Also, the tour guide's voice may not project adequately, particularly in large tour groups.

In addition to the accessibility and hearing issues noted above, the traditional guided tour is limited in many other ways. The tour guides do not have the capability to know the names of all participants of the guided tour. It is very difficult for the tour guide to keep track of the names of the participants and other details specific to each individual participant. There is also a limit to the amount of information the participants can retain after the guided tour, which makes it difficult for prospective students to make informed decisions after the tour is complete. This is further complicated by the fact that participants take numerous guided tours at multiple different universities, often over a relatively short period of time. The conventional guided tour also does not provide a reliable feedback mechanism that allows the university and the tour guide to make improvements to the tour experience based upon feedback received from participants. Also, if a participant must leave early before the tour is complete, there is no way for them to recover or access the portions they missed.

There is simply too much information for tour participants to retain, particularly when touring multiple universities in the space of a few days or weeks. There is also the difficulty of the tour guide gathering and answering each and every question participants have, thus leaving many questions unasked and unanswered. The typical guided campus tour also does not provide a mechanism for the university or the tour guide to know whether the participants liked the tour, what the participants liked about the university and campus, or whether the guided tour positively or negatively impacted their interest in the university. Universities generally do not have a feedback mechanism that provides for how the guided tour experience can be improved based upon the perceptions of or feedback from the participants.

Another challenge that may present itself during a guided tour is a language barrier that may exist if the tour guide and some of the participants speak in and understand different native languages. The typical guided tour experience may be somewhat limited in instances where a language barrier makes it difficult for the participant to follow along in real-time with the information the tour guide is providing verbally.

### SUMMARY OF THE INVENTION

The following is a summary of the invention that should provide to the reader a basic understanding of some aspects of the invention. This summary is not intended to identify critical components of the invention, nor in any way to delineate the scope of the invention. The sole purpose of this summary is to present in simplified language some aspects of the invention as a prelude to the more detailed description presented below.

Because of the aforementioned disadvantages and other problems in the art, it is desirable to provide a system used by a tour guide or event speaker to convert the tour guide's verbal narration into text that is transmitted to the mobile devices of tour participants in real-time during the tour or event.

There is described herein, among other things, an embodiment of a guided tour system comprising: a microphone on a tour guide speaker's mobile device to convert the speaker's verbal inputs into text through a web-based browser portal or downloadable app and transmit said text to the mobile device of each individual tour audience member in the form of an auto-scrolling, real time transcript through a web-based browser portal or downloadable app on each audience member's mobile device. This embodiment of the present invention enables the audience members or tour participants who are hearing impaired to access a live, closed captioning of the speaker's narration without the need for additional hearing assistive hardware.

In an embodiment of the guided tour event mobile app, the invention enables each audience member to interact with the transcription of the guided tour in real-time during the tour and also to retain the entire transcript after the tour has concluded.

In an embodiment of the present invention, each audience member is enabled to interact with the speaker during the guided tour or event using buttons within a portal displayed on the audience member's mobile device. The displayed buttons may include, by way of example, a “like/heart” button, a “question” button that alerts the speaker that an audience member wants to ask a question, a “photo” button for taking pictures during the tour or event, a “smile/laugh” button, and a text field enabling a participant to send a message or question to the speaker/guide during the event/tour.

In another embodiment of the present invention, a customizable survey is generated for each audience member (tour participant) that allows for the audience members to provide feedback following the tour event and other information relevant to the tour event's goals or purposes.

In an embodiment of the present invention, the entire transcript is generated for the sponsor of the tour event to review post-event for learning, training, and evaluation purposes such as analyzing engagement and interests of the audience members, assessing possible improvements of the speaker's presentation or tour narration, and assessing the needs of the audience. It is an object of the present invention for the hosting institution to have a record of relevant information from the tour that can be accessed post-event and used to improve the quality of future tours and events.

In an embodiment, the post-event report may include a transcript annotated with each audience member's interactions during the event and can further include a map view using geo-located location data from the speaker's mobile device for events that take place in more than one location, such as a live, guided tour. Tour location data may show trends such as where audience members asked the most questions, where audience members took the most photos, which comments by the speaker received the most positive feedback, etc.

In yet another embodiment, the present invention may also stream audio of the speaker's narration directly to each audience member's mobile device in real-time, thereby serving as an audio amplification mechanism where it may be difficult to otherwise hear the speaker's voice. It is an object of the present invention to enable audience members to understand what the speaker is saying under conditions where the speaker's voice is inaudible or difficult to perceive due to environmental conditions such as high winds, traffic noise and the like. This amplification would also provide accessibility to participants with visual impairments who are unable to view the live transcript.

### BRIEF DESCRIPTION OF THE DRAWINGS

FIG. 1 is an illustration showing a landing page from the tour or event Speaker user interface.

FIG. 2 is an illustration of the tour or event Speaker user interface of the present invention.

FIG. 3 is an illustration of the tour or event audience member user interface of the present invention.

FIG. 4 is another illustration of the tour or event audience member user interface of the present invention.

FIG. 5 is another illustration of the tour or event audience member user interface of the present invention.

FIG. 6 is another illustration of the tour or event audience member user interface of the present invention.

FIG. 7 is an illustration of an example data report generated by the present invention and accessible to the administrative staff of the institution sponsoring or hosting the guided tour or event.

FIG. 8 is an illustration of an example annotated transcript generated by the present invention and accessible by the administrative staff of the institution sponsoring or hosting the guided tour or event.

FIG. 9 is an illustration of an example data report generated by the present invention and accessible to the administrative staff of the institution sponsoring or hosting the guided tour or event.

FIG. 10 is an illustration of an example annotated transcript generated by the present invention and accessible by the administrative staff of the institution sponsoring or hosting the guided tour or event and Audience Members.

FIG. 11 is an illustration of a tour/event data report generated by the present invention and accessible by the Speaker.

FIG. 12 is an illustration of an example annotated tour/event transcript with no audience member annotations generated by the present invention and accessible by the Speaker.

FIG. 13 is an illustration of a tour/event data report generated by the present invention and accessible by the staff of the institution sponsoring or hosting the guided tour or event.

FIG. 14 is an illustration of a tour map generated by the present invention and accessible by the institution sponsoring or hosting the guided tour.

FIG. 15 is an illustration of a tour map, showing the path of a guided tour, generated by the present invention and accessible by the institution sponsoring or hosting the guided tour.

FIG. 16 is an illustration showing a landing page accessible by a staff member or employee of the institution sponsoring or hosting the guided tour or event when logging in to the system of the present invention.

FIG. 17 is an illustration showing a new user account page for a staff member or employee of the institution sponsoring or hosting the guided tour or event according to the present invention.

### DETAILED DESCRIPTION

The following detailed description is merely exemplary in nature and is not intended to and should not be interpreted to limit the embodiments described herein. Although particular embodiments are described, those embodiments are merely exemplary implementations of the present invention. The following descriptions herein should be considered illustrative in nature, and thus, not in any way limiting the scope of the present invention. One skilled in the art will recognize other embodiments are possible and all such embodiments are intended to fall within the scope of the present disclosure. It is the intent is to include all alternatives, modifications and equivalents that embody the spirit and scope of the disclosure.

It is also to be understood that the disclosure uses terminology for the purpose of describing particular embodiments and such terminology is not intended to be limiting.

Unless defined otherwise, all technical and scientific terms used in this disclosure have the same meaning as commonly understood by one of ordinary skill in the art to which is applicable to this disclosure.

As will be apparent to those of skill in the art upon reading this disclosure, each of the embodiments described herein has discrete components and features which may be readily separated or combined with features of any of the other possible embodiments without departing from the spirit and scope of the present disclosure.

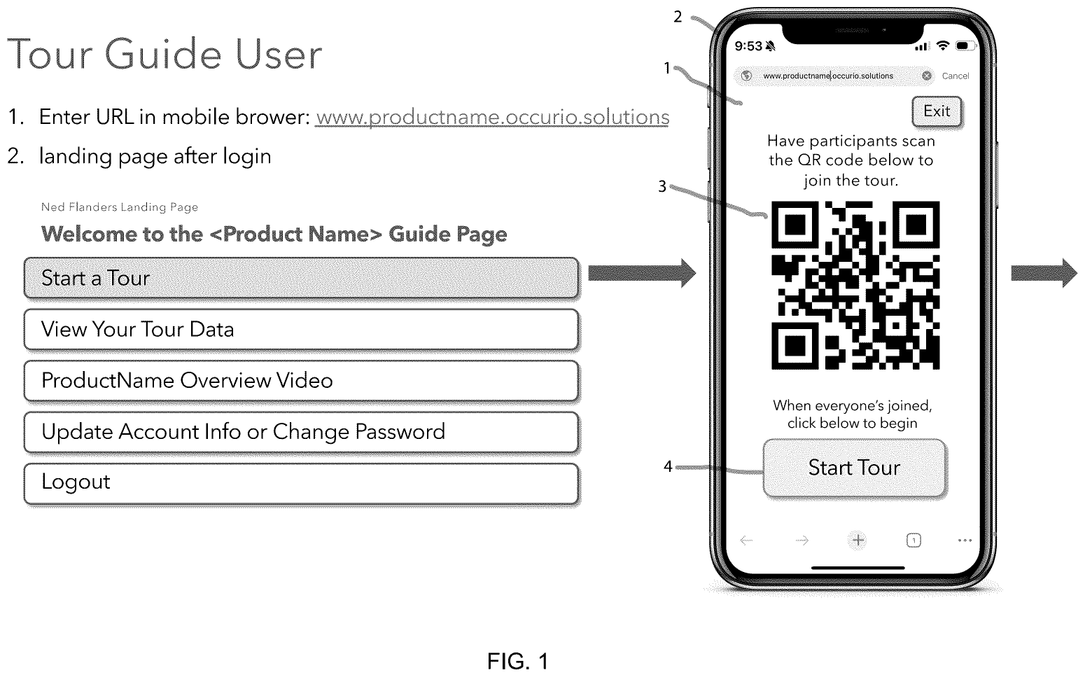

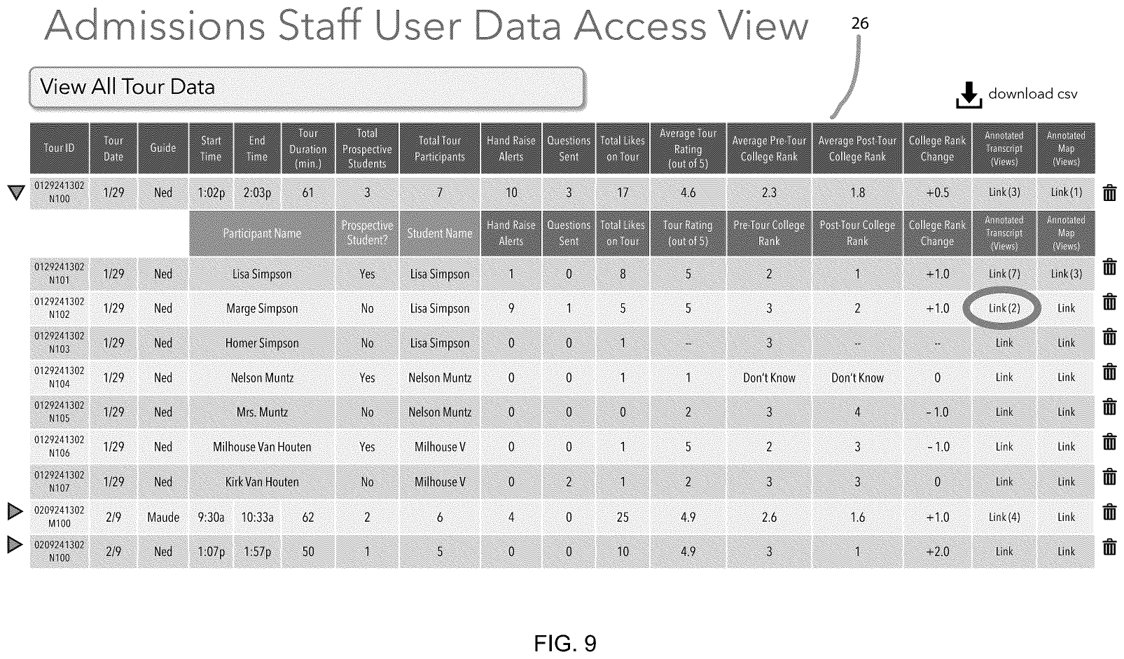

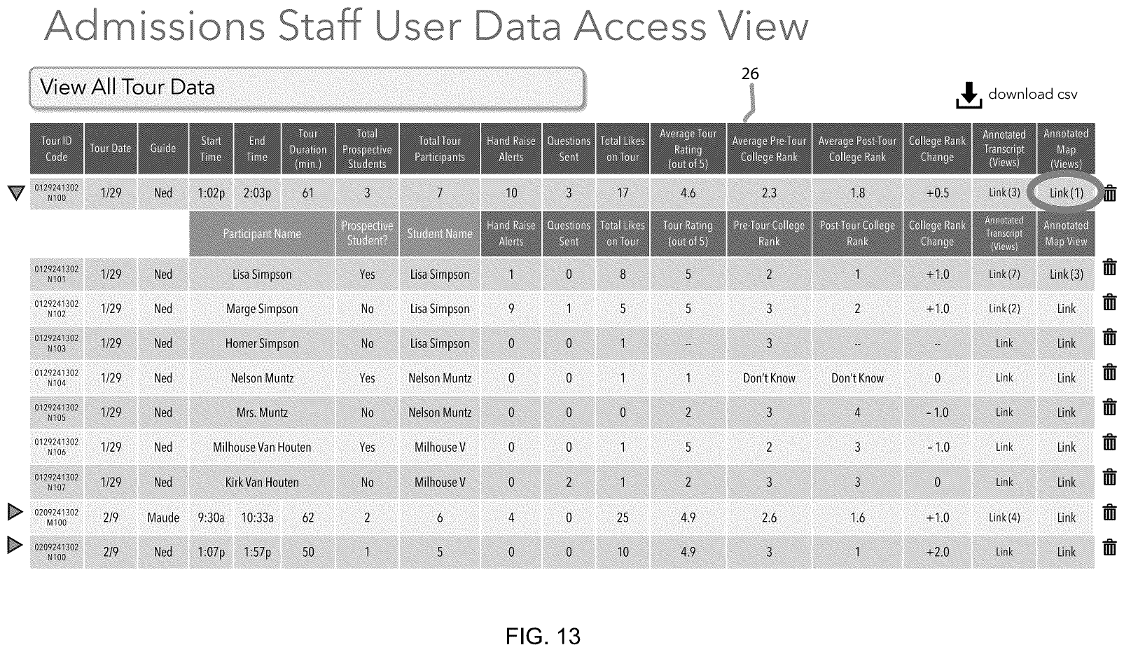

The present invention may be more fully described with reference to FIGS. 1-17. The present disclosure relates generally to voice-to-text audio transcription systems. More specifically, the present disclosure relates to interactive, real-time voice to text transcription systems and methods for using the same. Embodiments of systems described herein provide interactive, real-time display of voice-to-text transcription in a live, in-person event or guided tour setting, such as a guided on-campus college tour.

Systems and methods described herein enable hearing impaired individuals to effectively follow a live verbal presentation provided by a tour guide or event speaker (Speaker) in real time. Embodiments of the present invention can be implemented by the sponsor of any type of live event or guided tour, although the preferred embodiments described herein are specific to university-sponsored guided college campus tours. Even though the preferred embodiments described herein pertain specifically to college campus tours, the present invention is not limited to these particular types of tours and the present invention should be construed as suitable for purposes of any other type of guided tour or live, in-person event.

Turning to FIG. 1, in at least one embodiment, an interactive, real-time voice-to-text transcription system includes a cloud-based server accessible by guided tour participants from their mobile device, such as a smart phone or tablet. FIG. 1 illustrates a user interface 1 displayed on the Speaker's mobile device 2 (i.e., smartphone or tablet). As illustrated in FIG. 1, in a preferred embodiment, each guided tour participant (Audience Member) may access the system of the present invention from their mobile device by way of scanning a QR code 3 that is displayed on the user interface 1 on the Speaker's mobile device 2. In the preferred embodiment illustrated in FIG. 1, the Speaker may select “start tour” 4 from the Speaker user interface 1 after the Audience Members have scanned the appropriate QR code 3 to join the guided tour.

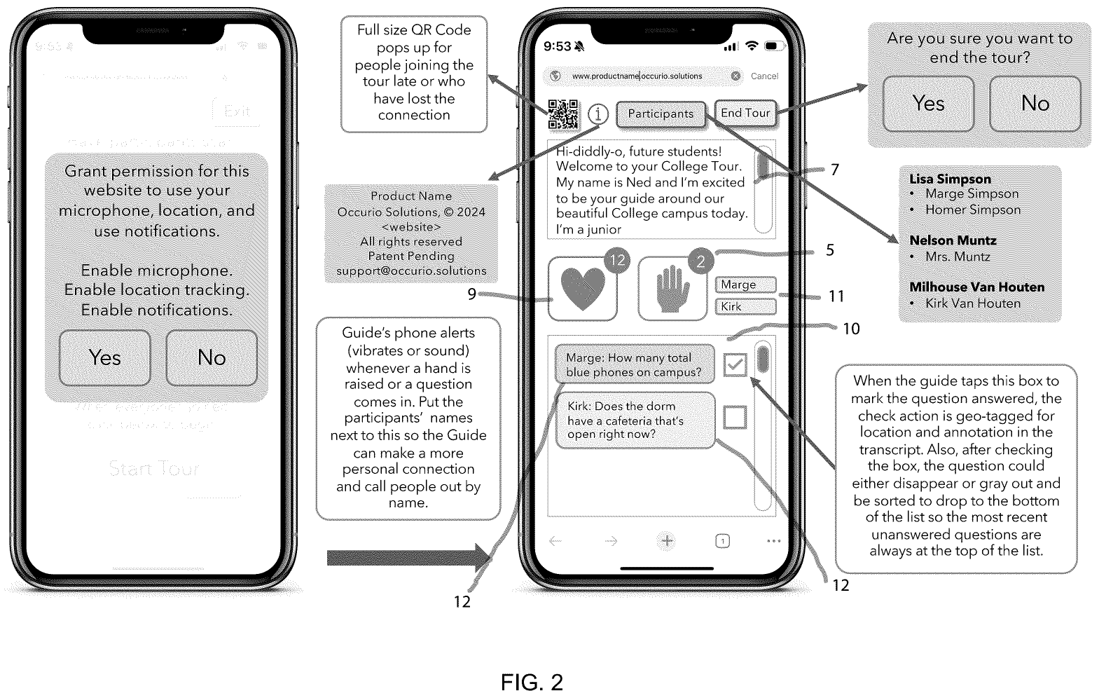

As shown in FIG. 2, the system of the present invention has a user interface 1 displayed on the Speaker's mobile device 2, whereby permissions may be granted for use of the Speaker's mobile device microphone, for use of the Speaker's location and for use of notifications on the Speaker's mobile device 2. FIG. 2 further illustrates how the Speaker's user interface 1 displays the number 5 of Audience Members who have raised their hand to notify the Speaker of a question or need along with the names 6 of the Audience Members so they can be addressed more personally by the Speaker, the real-time transcript 7 of the Speaker's verbal presentation, a “like” indicator 8 showing the total count of times that audience members have pushed their like button on the tour represented by a symbol such as the “heart” symbol 9 shown in FIG. 2, a “question” indicator 10 showing how many questions are being posed by Audience Members, the names 11 of the Audience Members who have a question pending, and the specific questions 12 posed by Audience Members in the form of text messages. In the preferred embodiment shown in FIG. 2, the system transcribes every word spoken by the Speaker, in real-time, and displays the Speaker's words captured by the microphone of the Speaker's mobile device 2.

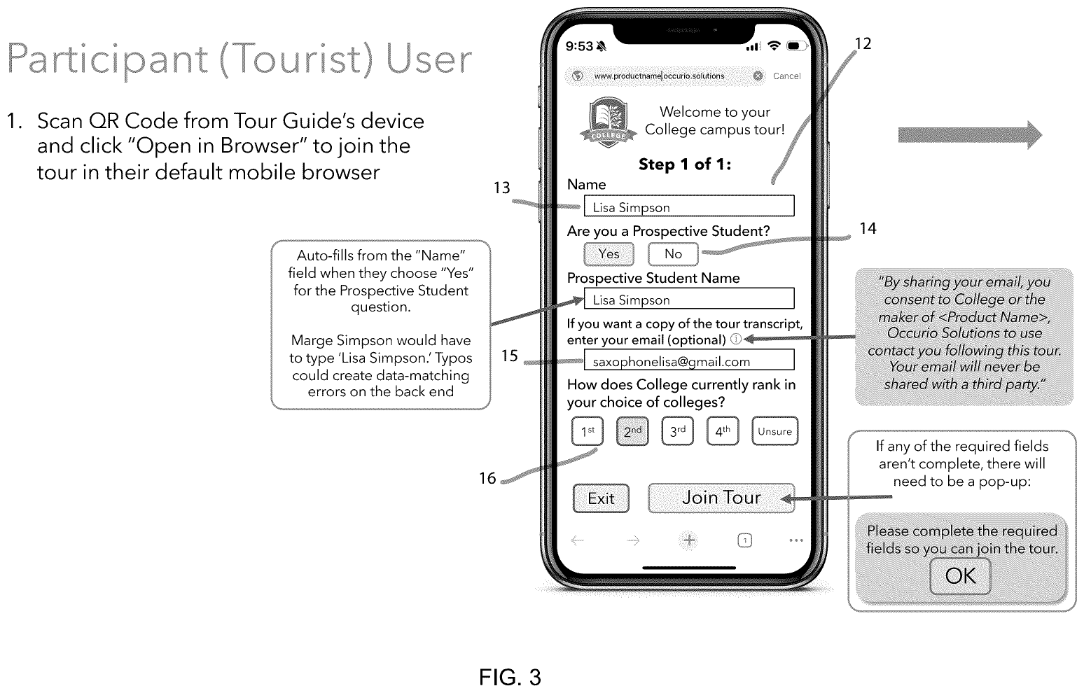

FIG. 3 illustrates the Audience Member user interface of a preferred embodiment of the present invention. As shown in FIG. 3, the Audience Member user interface 12 allows the Audience Member to input identifying information, such as their name 13, whether they are a prospective student 14, their email address 15, and their ranking 16 of the college providing the tour. Although FIG. 3 shows particular information that can be provided by the Audience Member, the present invention should not be considered limited in terms of the types of information that can be provided via the Audience Member user interface 12 and the system of the present invention can be designed to solicit any other types of desired information that the Sponsor of the tour or event would like to gather from Audience Members.

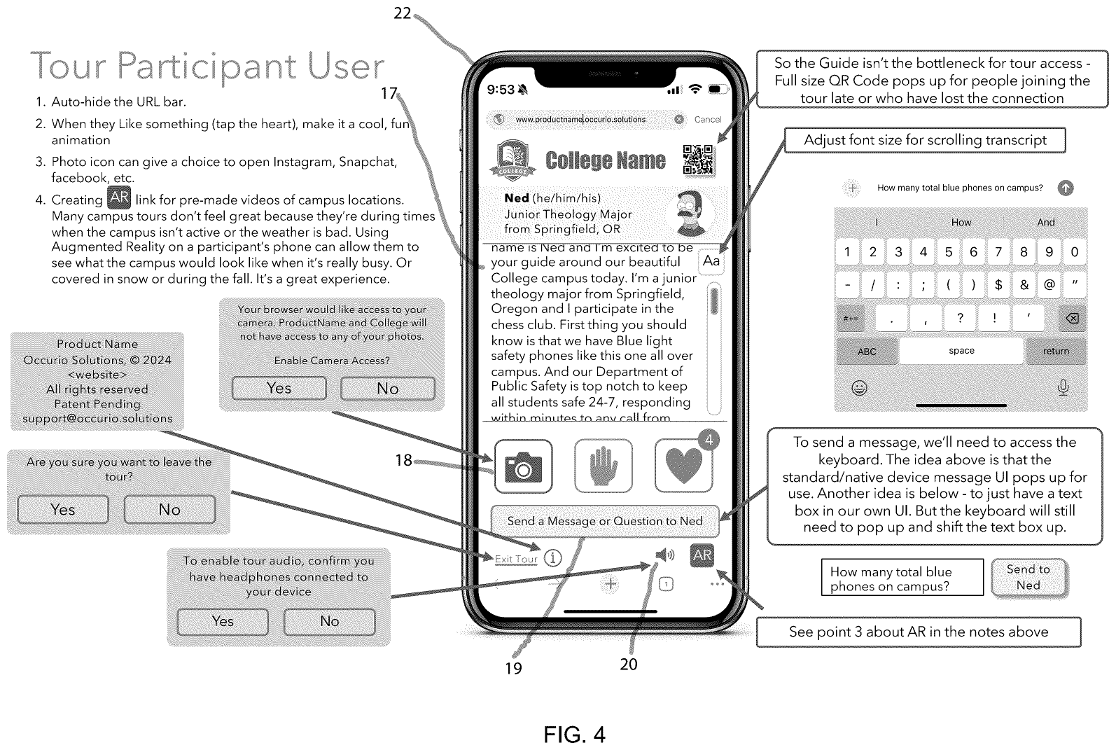

FIG. 4 illustrates the Audience Member user interface 12 of a preferred embodiment as it appears after the Audience Member joins the guided tour. As shown in FIG. 4, the Audience Member user interface 12 displays a real-time transcript 17 of the Speaker's verbal presentation. The Audience Member user interface 12 may also include touch screen options 18 that allow for a variety of actions, including allowing the Audience Member to access the camera of their mobile device to take a photo during the tour or event, indicating the Audience Member has a question for the Speaker, and indicating a “like” in response to something said by the Speaker. FIG. 4 further shows an embodiment where the Audience Member user interface also includes a text box 19 in which the Audience Member may type a question that is sent to the Speaker in real-time during the guided tour or event. The Audience Member user interface 12 may also, as shown in FIG. 4, include a point of contact 20 that allows the Audience Member to enable the tour audio to be heard via headphones or other suitable Bluetooth earpieces connected to the Audience Member's mobile device. The system also preferably displays a QR code 21 on the Audience Member user interface 12, that allows for Audience Members to help other Audience Members join or re-join the tour without having to scan the QR code 3 from the Speaker's mobile device 2. For the example of a college tour, the system would also make it possible for a family member, loved one or guardian who was unable to be on campus live for the tour, perhaps due to illness, to join the tour and follow the transcript remotely, thereby creating even more personal connections.

The voice-to-text transcription system, of at least one embodiment, includes a microphone built in the Speaker's mobile device that records the Speaker's voice and transmits the recorded audio to mobile devices through a cloud server. The cloud server transcribes the Speaker's recorded audio into text through any suitable transcription modality known in the art and transmits the text to the Audience Members' mobile devices 22 for the Audience Members to see and read.

The transcript 17 provided to Audience Members is preferably an auto-scrolling, real-time transcript generated on the mobile device 22 of each Audience Member through a web-based browser portal or downloadable software app on each Audience Member's mobile device 22. An embodiment of the present invention may further provide real-time language translation, converting the Speaker's recorded audio into a text transcript translated in a different language, thereby facilitating a real-time understanding of the Speaker's verbal presentation even where the Speaker and an Audience Member speak and understand different languages.

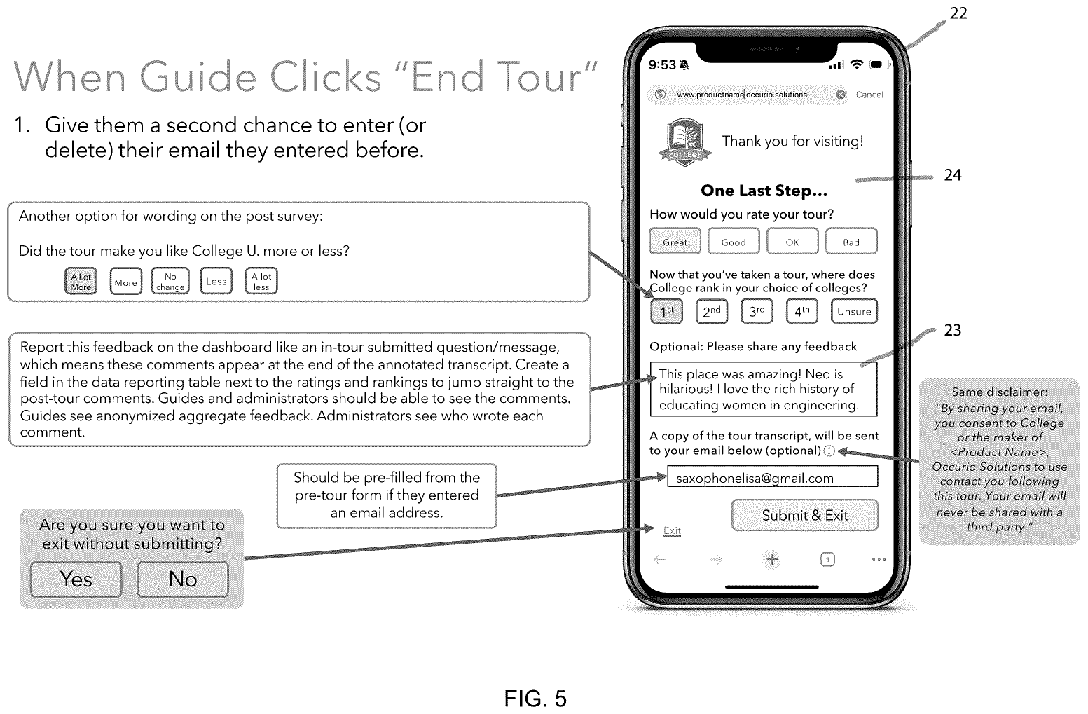

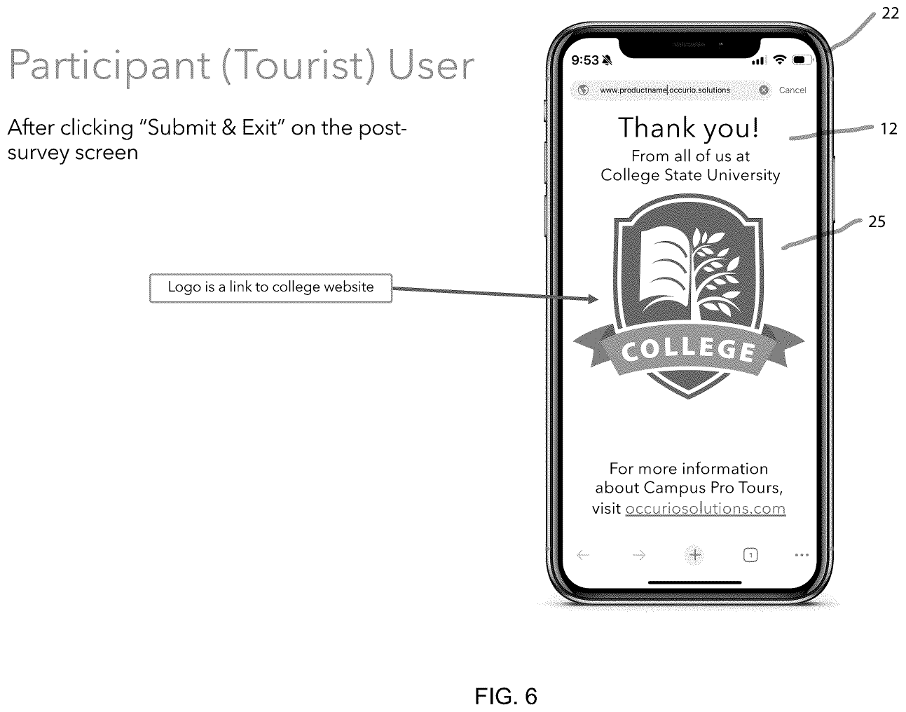

As illustrated in FIG. 5, upon the Speaker ending the tour from the Speaker's mobile device 2, the Audience Member user interface 12 preferably will display text window 23 as an option for the Audience Member to answer questions and provide feedback. For example, as shown in the embodiment illustrated in FIG. 5, the Audience Member user interface 12 may include a display 24 where the Audience Member may be asked to rate the tour, rank the sponsoring college among the colleges the Audience Member has visited, and to provide any other comments the Audience Member desires. The information solicited by the system of the present invention can be any information deemed of value to the institution sponsoring the tour. Finally, as shown in FIG. 6, upon the Audience Member submitting the requested survey information, the Audience Member user interface 12 will preferably display a “thank you” screen 25 with relevant links or calls to action.

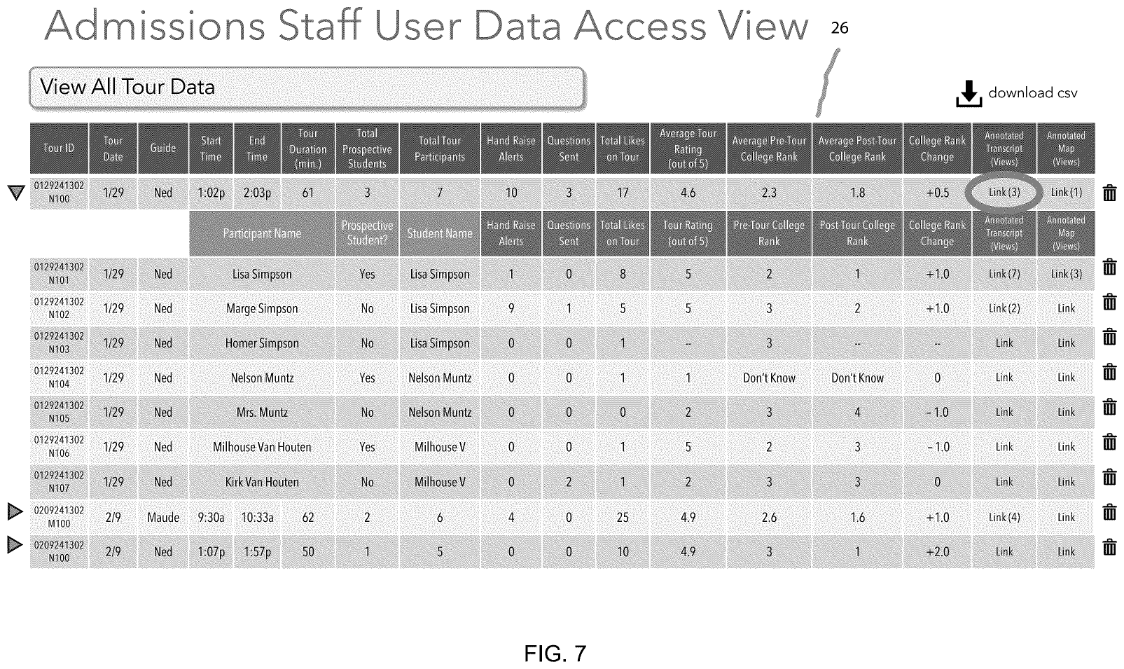

An embodiment of the present invention stores and generates a report 26 of a variety of different categories of data relevant to the tours hosted by the sponsoring institution which may include, as shown in FIGS. 7, 9 and 13, tour/event date and time, tour/event duration, number of prospective student attendees, number of tour participants, hand raise alerts, questions posed, total “likes” given, average tour rating, pre-tour and post-tour college rankings, annotated transcript and annotated map. The present invention is not limited to the aforementioned categories of data and any other data points that may be relevant to the hosting institutions may be added to the data gathering and data reporting features of the present invention.

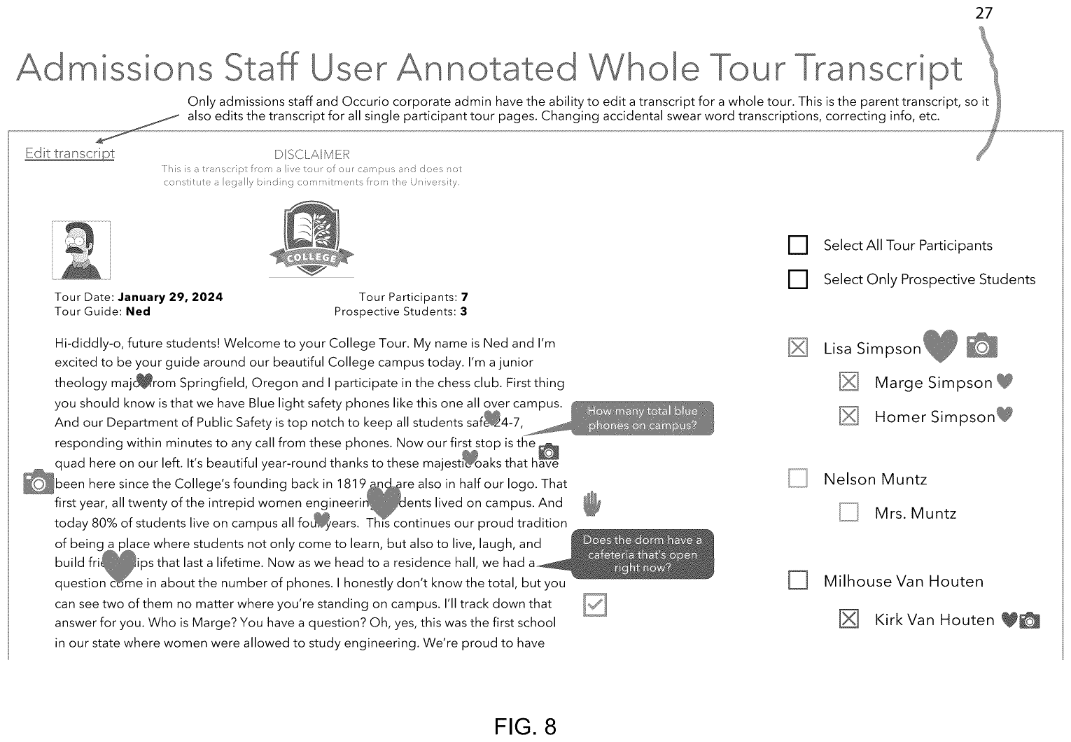

FIG. 8 illustrates an example of an annotated tour transcript 27 generated by an embodiment of the present invention, which displays “likes” given by Audience Members, questions posed by Audience Members, when those questions were answered, and when photos were taken. The system provides access to the transcript by the staff of the sponsoring institution and allows for the staff member to edit the transcript as needed (i.e., to make spelling corrections, to edit or delete portions that were mis-transcribed, etc.).

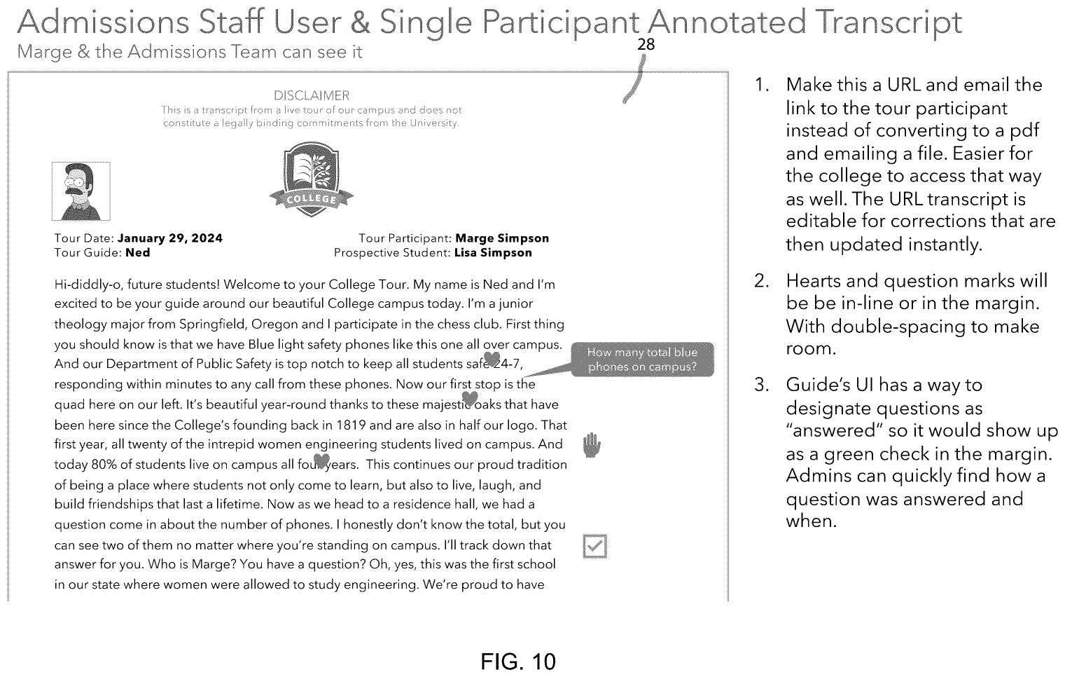

FIG. 10 illustrates an example of an annotated transcript 28 accessible by the staff of the host institution or an Audience Member that participated in the tour. As shown in FIG. 10, preferably the annotated transcript includes “likes” given during the tour and questions posed by Audience Members during the tour. The annotated transcript shown in FIG. 10 may be transmitted to the Audience Members via electronic mail in the form of a hyperlink provided in an e-mail or in the form of an attached pdf.

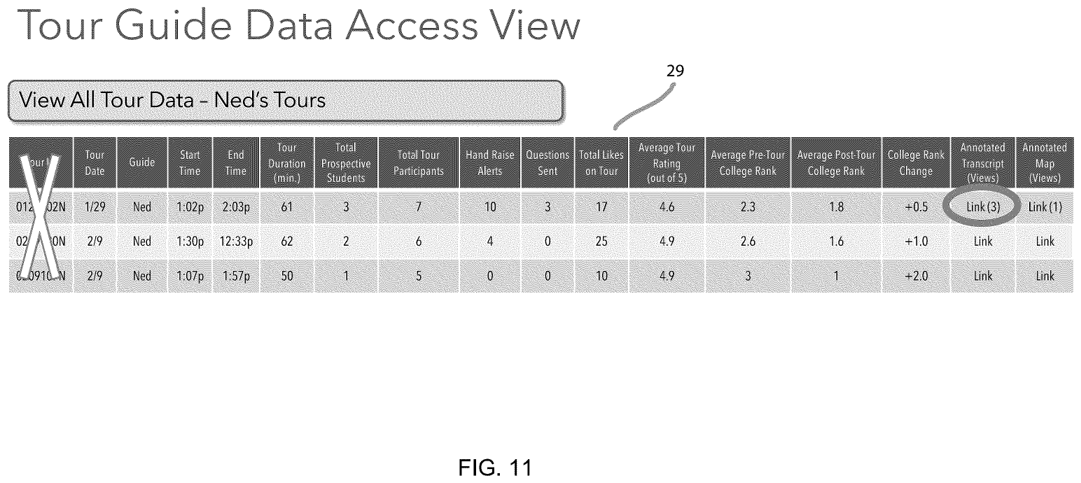

As shown in FIG. 11, an embodiment of the present invention also may provide a report of tour data 29 accessible by the Speaker who hosts a guided tour, including tour date, start and end times, total duration, total prospective students, number of hand raise alerts, number of questions asked, total number of “likes” given by Audience Members, tour rating data, college ranking data, an annotated transcript and an annotated map. The data and information provided to the Speaker in this manner is not in any way limited to the types of data shown on FIG. 11

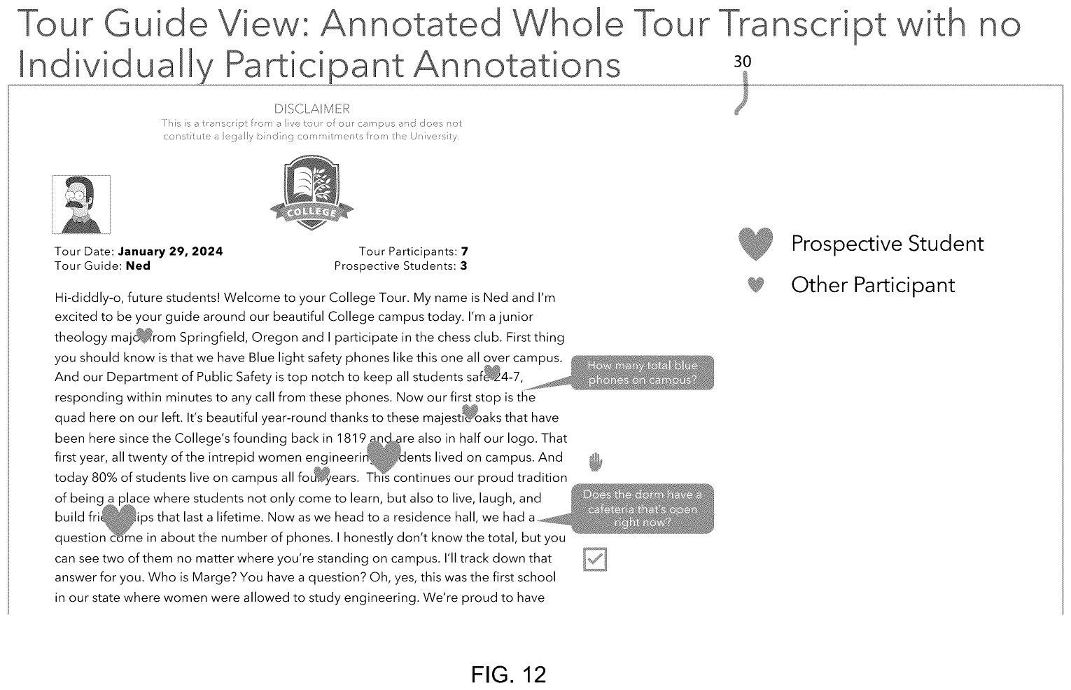

An embodiment of the present invention may also generate a tour transcript 30 with no individual Audience Member annotations, as shown in FIG. 12.

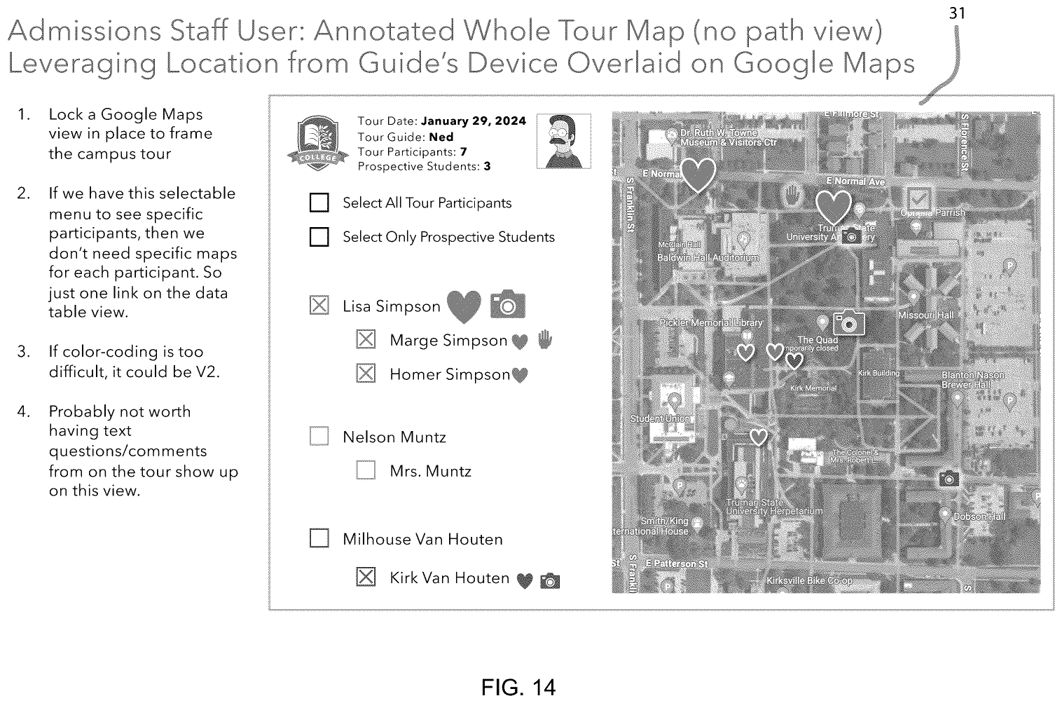

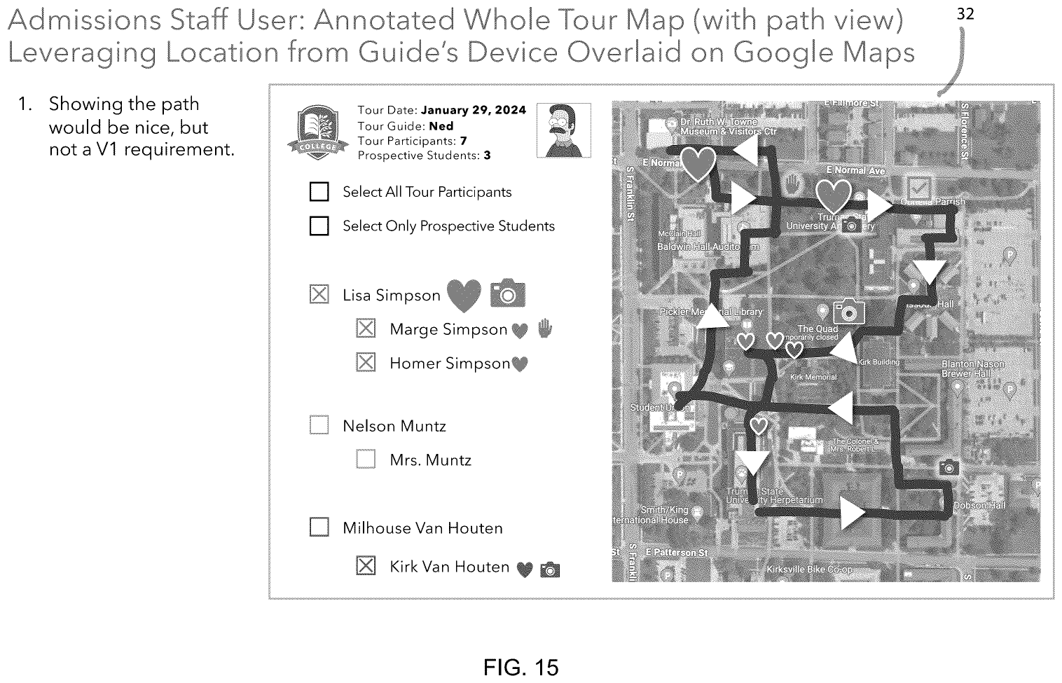

An embodiment of the present invention may further generate an annotated tour map 31, including location information generated by the Speaker's mobile device during a campus tour, as shown in FIG. 14. FIG. 14 shows an annotated map 31 with identifying information for Audience Members, locations where “likes” were sent by participating Audience Members and locations where photos were taken by particular Audience Members. FIG. 15 shows a similar example of an annotated map 32 generated by an embodiment of the present invention, including information that shows the path taken by the guided tour.

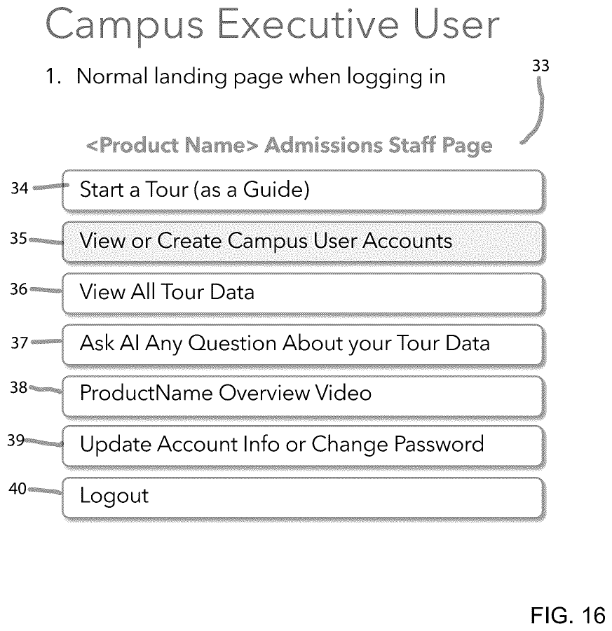

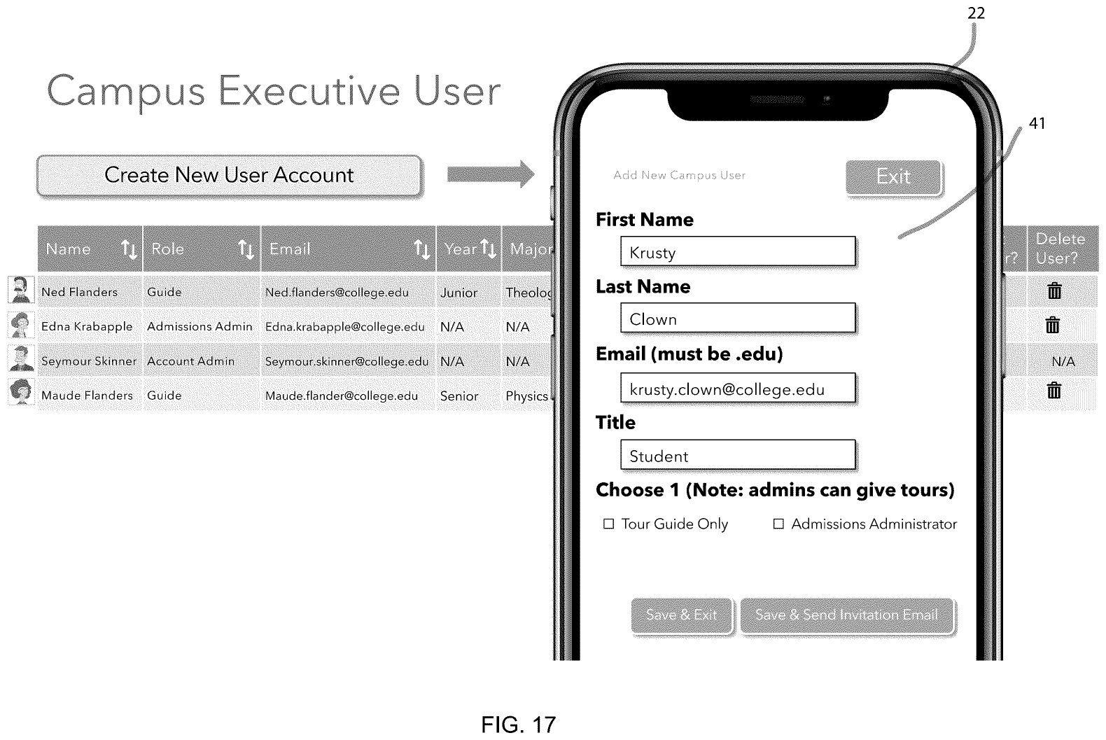

An embodiment may also include a landing page accessible by a staff member or employee of the sponsoring institution for logging into the system of the present invention. FIG. 16 shows an illustration of such an admissions staff log-in landing page 33, offering a variety of menu options, such as “start a tour,” 34 “view or create campus user accounts,” 35 “view all tour data,” 36 “ask AI any questions about your tour data,” 37 “product name overview video,” 38 “update account information or change password,” 39 and “logout” 40. FIG. 17 illustrates the appearance of the user interface 41 that appears on the user's mobile device 22 when selecting “create a new user account.”

The system described herein can be configured for transcribing the verbal output of more than one Speaker for a single guided tour or event and for Audience Members to provide real-time “likes” and questions to multiple Speakers guiding a single tour.

A further embodiment of the present invention advantageously includes the capability for Audience Members using mobile devices with Augmented Reality (AR) capabilities to use their mobile devices to access AR views created by the hosting institution, as they progress through the tour. For example, an Audience Member participating in a tour on a day where the toured campus has few students present may utilize AR on his or her mobile device to view how the campus looks on a day when many people are present and noticeable on campus.

Yet another embodiment of the present invention may further include Artificial Intelligence (AI) capabilities in data analysis and reporting to enable quicker, more efficient and more meaningful data analysis of annotated tour transcripts and annotated tour maps for improving tours and prospective student recruiting.

Another embodiment of the present invention may include a feature that allows for the Speaker to be alerted in the event a prospective student desires a campus tour, but has not scheduled a tour in advance. This embodiment would enable the prospective student to connect with a live, remote tour guide and employing the location capabilities of the system, the tour guide could follow the location of the prospective student and guide them around campus and deliver live narration remotely, ensuring a personal connection distinct from a pre-recorded, self-guided tour experience.

The user interfaces and data reports described herein may also advantageously include branding that is exclusive to the hosting institution, thereby highlighting the unique style, logo, colors and identity of the hosting institution.

In a preferred embodiment, a cloud-based server is the processor that performs the executable instructions necessary for the transcription of audio to text, described herein, including but not limited to accessing audio directed to or recorded from the Speaker's mobile device, transcribing the audio into text, receiving information and inputs from Audience Member mobile devices and transmitting such information and inputs to the Speaker's mobile device, generating post-event reports, and all other instructions necessary for the system and methods described herein.

Having described the preferred embodiment of the present invention, any number of changes, variations and improvements which may be apparent to those skilled in the art are within the scope of the invention claimed and described herein.

What is claimed is:

1. A non-transitory computer-readable medium having stored contents that cause one or more devices to perform automated operations, the automated operations including:
at least one device of the one or more devices generating an audio recording using a microphone;
creating a real-time transcript of the audio recording;
causing the transcript to be displayed as text on a client device.

2. The non-transitory computer-readable medium of claim 1 wherein the device generating the audio recording is a speaker's mobile computing device.

3. The non-transitory computer-readable medium of claim 1 wherein the client device is a mobile computing device.

4. The non-transitory computer-readable medium of claim 1 wherein the client device transmits information to the speaker's mobile computing device.

5. The non-transitory computer-readable medium of claim 4 wherein the client device displays a plurality of buttons that permit a client user to select a particular type of information to be transmitted to the speaker's mobile computing device.

6. The non-transitory computer-readable medium of claim 5 wherein the plurality of buttons can be any one or more of a like button, a question button, a smile button or a photo button for taking photographs with the client device.

7. The non-transitory computer-readable medium of claim 1 wherein the automated operations further include generating a customizable survey displayed on the client device and transmitting information a client inputs into the customizable survey from the client device to the device generating an audio recording.

8. The non-transitory computer-readable medium of claim 1 wherein the automated operations further include generating a post-event report.

9. The non-transitory computer-readable medium of claim 8 wherein the post-event report includes a transcript annotated with one or more client interactions.

10. The non-transitory computer-readable medium of claim 8 wherein the post-event report includes a map view using geo-located location data from the device generating an audio recording.

11. The non-transitory computer-readable medium of claim 1 wherein the automated operations further include editing or correcting the transcript in real-time.

12. The non-transitory computer-readable medium of claim 1 wherein the automated operations further include streaming audio from the device generating an audio recording to one or more client devices in real-time.

13. A real-time voice-to-text transcription system comprising:
A cloud-based server accessible by one or more mobile devices wherein said server is operable to cause the real-time voice-to-text transcription system to:
access audio in the form of a speaker's spoken words into a microphone on the speaker's mobile device;
cause the text to be displayed in real-time on a client mobile device as the audio is spoken into the microphone on the speaker's mobile device;
transmit in real-time to the speaker's mobile device, information input into the client mobile device; and
generate a written transcript of the words spoken by the speaker.

14. A method for providing real-time voice-to-text transcription, the method comprising the steps of:
providing a real-time voice-to-text system including a cloud-based server;
accessing with the real-time voice-to-text system audio in the form of words spoken into a microphone of a speaker's mobile device;
transcribing with the real-time voice-to-text system the audio into text;
causing by the real-time voice-to-text system the text to be displayed on one or more client mobile devices in real-time as words are spoken into the speaker's mobile device;
transmitting in real-time inputs entered into the one or more client mobile devices to the speaker's mobile device; and
generating a transcript of the words spoken into the speaker's mobile device.
